(19) United States
(12) Patent Application Publication
(10) Pub. No.: US 2020/0228784 A1
(43) Pub. Date: Jul. 16, 2020

(54) FEEDBACK BASED SCANNING SYSTEM AND METHODS

(71) Applicant: Guangdong Kang Yun Technologies Limited, Guangzhou City (CN)

(72) Inventor: Seng Fook Lee, Guangzhou City (CN)

(21) Appl. No.: 16/616,176

(22) PCT Filed: Jun. 15, 2018
(86) PCT No.: PCT/CN2018/091529

§ 371 Date: Nov. 22, 2019

Related U.S. Application Data
(60) Provisional application No. 62/580,464, filed on Nov. 2, 2017.

(51) Int. Cl. H04N 13/254; H04N 5/232; H04N 13/111

(52) U.S. Cl. CPC H04N 13/254; H04N 13/111; H04N 5/23222

(57) ABSTRACT

Systems and methods are provided for scanning of an object. A feedback-based laser-guided scanning system includes a processor for defining a laser center coordinate and a relative width for the object from a first shot; and defining an exact position for taking each of shots after the first shot, the exact position for taking the shots is defined based on the laser center coordinate and the relative width. The system also includes a feedback module configured to provide at least one feedback about the exact position for taking the shots. The system includes cameras for capturing the first shot and the shots one by one based on the feedback; a user moves the system to the exact position. The processor may stich and process the first shot and the shots in real-time to generate a 3D model including a scanned image of the object.

### CROSS REFERENCE TO RELATED APPLICATIONS

This application is a national stage application under 35 U.S.C. 371 of PCT Application No. PCT/CN2018/091529, filed 15 Jun. 2018, which PCT application claimed the benefit of U.S. Provisional Patent Application No. 62/580,464, filed 2 Nov. 2017, the entire disclosure of each of which are hereby incorporated herein by reference.

### TECHNICAL FIELD

The presently disclosed embodiments relate to the field of imaging and scanning technologies. More specifically, embodiments of the present disclosure relate to laser-guided scanning systems and methods for scanning of objects based on a feedback.

### BACKGROUND

A three-dimensional (3D) scanner may be a device capable of analysing environment or a real-world object for collecting data about its shape and appearance, for example, colour, height, length width, and so forth. The collected data may be used to construct digital three-dimensional models. Usually, 3D laser scanners create “point clouds” of data from a surface of an object. Further, in the 3D laser scanning, physical object's exact size and shape is captured and stored as a digital 3-dimensional representation. The digital 3-dimensional representation may be used for further computation. The 3D laser scanners work by measuring a horizontal angle by sending a laser beam all over the field of view. Whenever the laser beam hits a reflective surface, it is reflected back into the direction of the 3D laser scanner.

In the present 3D scanners or systems, there exist multiple limitations. For example, a higher number of pictures need to be taken by a user for making a 360-degree view. Also the 3D scanners take more time for taking or capturing pictures. Further, a stitching time is more for combining the more number of pictures (or images). Similarly, the processing time for processing the more number of pictures increases. Further, because of more number of pictures, the final scanned picture becomes heavier in size and may require more storage space.

### SUMMARY

In light of above discussion, there exists need for better techniques for scanning and primarily 3D scanning of objects. The present disclosure provides methods and systems for laser-guided 3D scanning of objects based on a feedback.

An objective of the present disclosure is to provide a feedback-based laser-guided scanning system for scanning of at least one of symmetrical and unsymmetrical objects.

Another objective of the present disclosure is to provide a method for scanning of at least one of symmetrical and unsymmetrical objects based on a feedback.

Another objective of the present disclosure is to provide a feedback-based scanning system for generating at least one 3D model comprising a scanned image of the object.

Another objective of the present disclosure is to indicate an exact position to the user for taking a shot of an object via a feedback. This way less number of shots may be taken from the exact positions for defining a 360-degree view of the object.

Another objective of the present disclosure is to provide a method for 3D scanning of at least one of symmetrical and unsymmetrical objects based on a feedback.

An objective of the present disclosure is to provide a feedback-based laser-guided scanning system and a method for a three-dimensional (3D) scanning of at least one of symmetrical and unsymmetrical objects based on one or more feedbacks providing an exact position for taking shots of the object.

The present disclosure provides feedback-based laser-guided coordinate systems and methods for advising an exact position to the user for taking one or more shots comprising one or more photos of an object one by one by providing an audio feedback or a video feedback about the exact position.

The present disclosure also provides feedback-based systems and methods for generating three-dimensional (3D) model including at least one scanned image of an object comprising a symmetrical and an unsymmetrical object or of an environment.

The present disclosure also provides feedback-based systems and methods for generating a 3D model including scanned images of object(s) by allowing the user to click a less number of images or shots for completing a 360-degree view of the object.

The present disclosure also provides feedback based scanning systems and methods for generating a 3D model including scanned images of object(s) in real-time.

An embodiment of the present disclosure provides a laser-guided scanning system for scanning of an object. The laser-guided scanning system includes a processor configured to: define a laser center coordinate and a relative width for the object from a first shot of the object; and define an exact position for taking each of one or more shots after the first shot, wherein the exact position for taking the one or more shots is defined based on the laser center coordinate and the relative width. The system also includes a feedback module configured to provide at least one feedback about the exact position for taking the one or more shots. The system further includes one or more cameras configured to capture the first shot and the one or more shots one by one from the exact position based on the feedback, wherein a user moves the laser-guided scanning system to the exact position. In some embodiments, the user moves the system to the exact position for taking each of the plurality of shots. The processor is further configured to stich and process the first shot and the one or more shots in real-time to generate at least one three-dimensional (3D) model including a scanned image of the object.

Another embodiment of the present disclosure provides a feedback-based laser-guided scanning system for scanning of an object. The feedback-based laser-guided scanning system includes an audio/video feedback module configured to provide a feedback about an exact position to a user for taking a plurality of shots comprising at least one image of an object, the feedback module further comprises a screen for showing information of scanning to the user, wherein the screen comprises at least one of a built in or a mounted visual system to showcase accuracy of taking shots to the user, the feedback comprising at least one of an audio message and a video message. The feedback-based laser-guided scanning system further includes one or more cameras configured to capture the plurality of shots including the first shot and one or more shots one by one based on the feedback. The one or more shots may be taken after the first shot. The feedback-based laser-guided scanning system further includes a processor configured to define a laser center coordinate for the object from a first shot of the plurality of shots; define the exact position for taking a next shot of the one or more shots without disturbing the laser center coordinate for the object; and stitch and process the first shot and the one or more shots in real-time to generate at least one 3D model comprising a scanned image of the object.

A yet another embodiment of the present disclosure provides a method for scanning an object based on a feedback. The method includes defining a laser center coordinate and a relative width for the object from a first shot of the object. The method further includes defining an exact position for taking each of one or more shots after the first shot, wherein the exact position for taking the one or more shots is defined based on the laser center coordinate and the relative width. The method also includes providing at least one feedback about the exact position to a user for taking the one or more shots. The method also includes showing information of scanning to the user for taking shots with accuracy to the user. The method further includes capturing the first shot and the one or more shots one by one from the exact position based on the feedback, wherein a user moves the laser-guided scanning system to the exact position. The method furthermore includes stitching and processing the first shot and the one or more shots in real-time to generate at least one three-dimensional model comprising a scanned image of the object.

Another embodiment of the present disclosure provides a method for three-dimensional (3D) scanning an object based on a feedback. The method includes providing at least one feedback about an exact position to a user for taking a plurality of shots comprising at least one image of an object, wherein the feedback comprising at least one of an audio message and a video message. The method further includes displaying information of scanning to the user for taking shots with accuracy to the user. The method also includes capturing the plurality of shots one by one based on the feedback-based on an input from the user. The method also includes defining a laser center coordinate for the object from a first shot of the plurality of shots. The method further includes defining the exact position for taking each of the one or more shots without disturbing the laser center coordinate for the object. The method further includes stitching and processing the first shot and the one or more shots to generate at least one three-dimensional model comprising a scanned image of the object.

According to an aspect of the present disclosure, the laser center coordinate is kept un-disturbed while taking the plurality of shots of the object.

According to another aspect of the present disclosure, wherein the object comprises at least one of a symmetrical object and an unsymmetrical object.

According to an aspect of the present disclosure, the feedback may include at least one of an audio feedback comprising an audio message and a video feedback comprising a video message.

According to another aspect of the present disclosure, wherein the one or more cameras takes the one or more shots of the object one by one based on the laser center coordinate and a relative width of the first shot.

According to an aspect of the present disclosure, the method also includes creating a sound to provide scanning information to the user for taking a next shot of the one or more shots.

According to yet another aspect of the present disclosure, wherein the processor is further configured to define a new position coordinate for the user based on the laser center coordinate and the relative width of the first shot.

According to an aspect of the preset disclosure, the processor may define a laser center coordinate for the object from a first shot of a plurality of shots, wherein the processor defines the exact position for taking the subsequent shot without disturbing the laser center coordinate for the object.

According to an aspect of the present disclosure, the feedback module comprises at least on speaker for generating a sound to provide information to the user for taking a next shot of the one or more shots.

According to an aspect of the present disclosure, the laser center coordinate is kept undisturbed while taking the one or more shots of the object.

According to an aspect of the present disclosure, the screen is configured to display/present scanning information for taking the one or more shots to the user.

According to another aspect of the present disclosure, the one or more cameras takes the one or more shots of the object one by one based on an audio/video feedback for each of the one or more shots.

According to another aspect of the present disclosure, the processor is further configured to define a new position coordinate based on the laser center coordinate and the relative width of the first shot.

According to another aspect of the present disclosure, the plurality of shots is taken one by one with a time interval between two subsequent shots.

According to another aspect of the present disclosure, a user takes a first shot, i.e. N1, of an object and the laser-guided scanning system may define a laser center coordinate for the object based on the first shot. For the second shot, an audio/video feedback may be provided for indicating an exact position to the user for the second shot i.e. N2 shot and so on for third shot (i.e. N3), fourth shot (i.e. N4), and so forth. Further, the user may require taking more than one shot for completing a 360-degree view or a 3D view of the object. The laser-guided scanning system may smartly define the N2, N3, and N4 position for clicking taking shots/images.

According to another aspect of the present disclosure, a user may be required to take multiple shots or capture multiple images or photos of an object based on a feedback for each of the shots for completing a 360-degree view or a three-dimensional (3D) view of the object. In some embodiments, the object may be a symmetrical object. In alternative embodiments, the object may be an unsymmetrical object. The unsymmetrical object comprises at least one uneven surface.

According to an aspect of the present disclosure, the processor may be configured to stich and process the shots post scanning of the object to generate at least one 3D model comprising a scanned image.

According to another aspect of the present disclosure, the processor may be configured to stich and process the shots of the object in real-time to generate at least one 3D model comprising a scanned image.

According to another aspect of the present disclosure, the feedback-based laser-guided scanning system is configured to keep the laser center coordinate undisturbed while taking various shots. The laser-guided scanning system may take the shots based on the coordinate. A relative width of the shot may also be defined to help in defining the new coordinate of the user. Therefore, by not disturbing the laser center, the laser-guided scanning system may capture the overall or complete photo of the object. Hence, there may not be a missing part of the object scanning that in turn, may increase the overall quality of the scanned image or the 3D model.

According to another aspect of the present disclosure, the one or more cameras takes the plurality of shots of the object one by one based on the laser center coordinate and a relative width of the first shot.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 illustrates an exemplary environment where various embodiments of the present disclosure may function;

FIG. 2 illustrates a schematic view of an exemplary feedback-based laser-guided scanning system according to an embodiment of the present disclosure;

FIG. 3 is a block diagram illustrating system elements of an exemplary feedback-based laser-guided scanning system, in accordance with an embodiment of the present disclosure;

FIGS. 4A-4B illustrate a flowchart of a method for three-dimensional (3D) scanning of an object based on one or more audio feedbacks, in accordance with an embodiment of the present disclosure; and

FIGS. 5A-5B illustrates a flowchart of a method for three-dimensional (3D) scanning of an object based on one or more video feedbacks, in accordance with an embodiment of the present disclosure.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). To facilitate understanding, like reference numerals have been used, where possible, to designate like elements common to the figures.

### DETAILED DESCRIPTION

The presently disclosed subject matter is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

Reference throughout this specification to “a select embodiment”, “one embodiment” or “an embodiment” means that a particular feature, structure, or characteristic described in connection with the embodiment is included in at least one embodiment of the disclosed subject matter. Thus, appearances of the phrases “a select embodiment” “in one embodiment” or “in an embodiment” in various places throughout this specification are not necessarily referring to the same embodiment.

Furthermore, the described features, structures, or characteristics may be combined in any suitable manner in one or more embodiments. In the following description, numerous specific details are provided, to provide a thorough understanding of embodiments of the disclosed subject matter. One skilled in the relevant art will recognize, however, that the disclosed subject matter can be practiced without one or more of the specific details, or with other methods, components, materials, etc. In other instances, well-known structures, materials, or operations are not shown or described in detail to avoid obscuring aspects of the disclosed subject matter.

All numeric values are herein assumed to be modified by the term “about,” whether or not explicitly indicated. The term “about” generally refers to a range of numbers that one of skill in the art would consider equivalent to the recited value (i.e., having the same or substantially the same function or result). In many instances, the terms “about” may include numbers that are rounded to the nearest significant figure. The recitation of numerical ranges by endpoints includes all numbers within that range (e.g., 1 to 5 includes 1, 1.5, 2, 2.75, 3, 3.80, 4, and 5).

As used in this specification and the appended claims, the singular forms “a,” “an,” and “the” include or otherwise refer to singular as well as plural referents, unless the content clearly dictates otherwise. As used in this specification and the appended claims, the term “or” is generally employed to include “and/or,” unless the content clearly dictates otherwise.

The following detailed description should be read with reference to the drawings, in which similar elements in different drawings are identified with the same reference numbers. The drawings, which are not necessarily to scale, depict illustrative embodiments and are not intended to limit the scope of the disclosure.

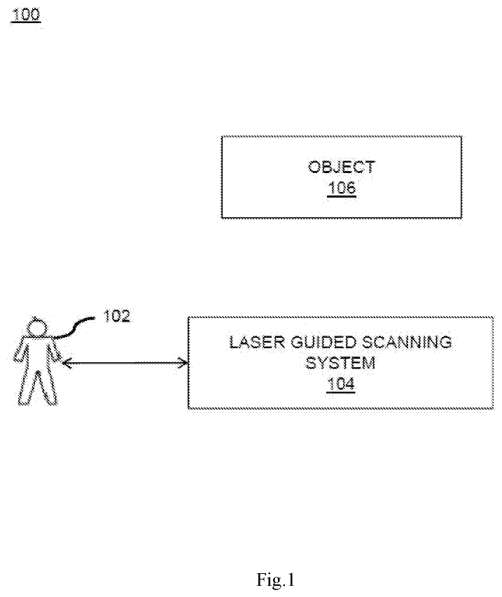

FIG. 1 illustrates an exemplary environment 100 where various embodiments of the present disclosure may function. As shown, the environment 100 primarily includes a user 102, a feedback-based laser-guided scanning system 104 for scanning of an object 106. In some embodiments, the user 102 may use the feedback-based laser-guided scanning system 104 to capture shots for three-dimensional scanning of the object 106 based on a feedback and at least one user input. The feedback may provide/display a new coordinate for taking a next shot of one or more shots of the object 106. The user 102 may move the feedback-based lased guided scanning system 104 to the exact position for taking the shot. The feedback may include an audio feedback, a video feedback, and combination of these. The audio feedback may include sounds, audio messages, and so forth. The video feedback may include video messages, displayed text, and so forth. In some embodiments, the user 102 accesses the feedback-based laser-guided scanning system 104 directly.

Further, the object 106 may be a symmetrical object and an unsymmetrical object. Examples of the object 106 may include a person, a chair, a building, a house, an electric appliance, and so forth. Though only one object 106 is shown, but a person ordinarily skilled in the art will appreciate that the environment 100 may include more than one object 106.

In some embodiments, the feedback-based laser-guided scanning system 104 is configured to 3D scan the object 106. Hereinafter, the feedback-based laser-guided scanning system 104 may be referred as a feedback-based scanning system 104 without change in its meaning. In some embodiments, the feedback-based laser-guided scanning system 104 is configured to capture one or more images of the object 106 for completing a 360-degree view of the object 106. Further in some embodiments, the feedback-based laser-guided scanning system 104 may be configured to generate 3D scanned models and images of the object 106. In some embodiments, the feedback-based laser-guided scanning system 104 may be a device or a combination of multiple devices, configured to analyse a real-world object or an environment and may collect/capture data about its shape and appearance, for example, colour, height, length width, and so forth. The feedback-based laser-guided scanning system 104 may use the collected data to construct a digital three-dimensional model. The feedback-based laser-guided scanning system 104 may indicate/signal via a feedback to the user 102 for taking one or more shots or images of the object 106. For example, the feedback-based laser-guided scanning system 104 may create a sound for indicating an exact position for taking a shot to the user 102. For taking each of the shots, the feedback-based laser-guided scanning system 104 points a green light to an exact location to the user 102 for taking the shot of the object 106. The feedback-based laser-guided scanning system 104 may provide one or more feedback to the user 102 for taking the one or more shots one by one. For instance the user 102 may provide a feedback F1 for taking a shot N1, a feedback F2 for taking a shot N2, and so on.

Further, the feedback-based laser-guided scanning system 104 may define a laser center coordinate for the object 106 from a first shot. Further, the feedback-based laser-guided scanning system 104 may define the exact position for taking the one or more shots without disturbing the laser center coordinate for the object 106. Further, the feedback-based laser-guided scanning system 104 is configured to define a new position coordinate of the user 102 based on the laser center coordinate and a relative width of the shot. The feedback-based laser-guided scanning system 104 may be configured to capture the one or more shots of the object 106 one by one based on the one or more feedbacks. In some embodiments, the feedback-based laser-guided scanning system 104 may take the one or more shots of the object 106 one by one based on the laser center coordinate and a relative width of a first shot of the shots. The one or more shots may refer to shots taken one by one after the first shot. Further, the feedback-based laser-guided scanning system 104 may capture multiple shots of the object 106 for completing a 360-degree view of the object 106. Furthermore, the feedback-based laser-guided scanning system 104 may stitch and process the multiple shots to generate at least one 3D model including a scanned image of the object 106.

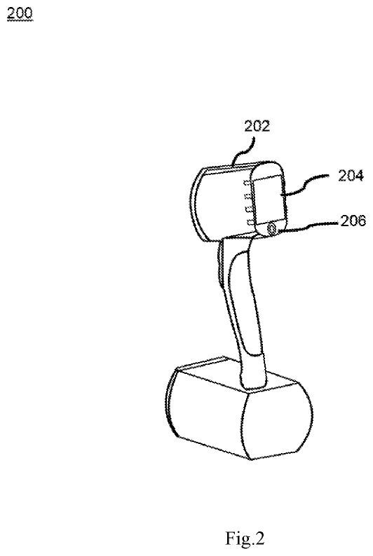

FIG. 2 illustrates a schematic view 200 of an exemplary feedback-based laser-guided scanning system 202 according to an embodiment of the present disclosure. As shown, the feedback-based laser-guided scanning system 202 includes a screen 204 for providing or displaying a feedback including a video feedback to the user 102 about an exact position for taking a shot of an object such as the object 106 as discussed with reference to FIG. 1. For example, a video message or a text message including exact position information or other scanning information may be displayed on the screen 204. The user 102 may move the feedback-based lased guided scanning system 202 to the exact position for taking the shot. The feedback-based laser-guided scanning system 202 may also include at least one inbuilt speaker for providing audio feedbacks. The feedback may include a new coordinate for taking a next shot of one or more shots of the object 106. The audio feedback may include sounds, audio messages, and so forth. The video feedback may include video messages, displayed text, and so forth.

Further, the feedback-based laser-guided scanning system 202 includes at least one camera 206 for capturing one or more shots of the object 106 one by one based on the feedback. In some embodiments, the feedback-based laser-guided scanning system 202 may also include a button (not shown) for taking shots and images of the object 106. In some embodiments, the camera 206 may take a first shot and the one or more shots of the object 106 based on a laser center coordinate and a relative width of the first shot such that the laser center coordinate remains undisturbed while taking the plurality of shots of the object.

The feedback-based laser-guided scanning system 202 may stitch and process the shots including the first shot and the one or more shots into an at least one 3D model comprising a scanned image of the object 106 in real-time. The feedback-based laser-guided scanning system 202 is configured to process the shots in real-time which in turn reduces the processing time for generating the at least one 3D model.

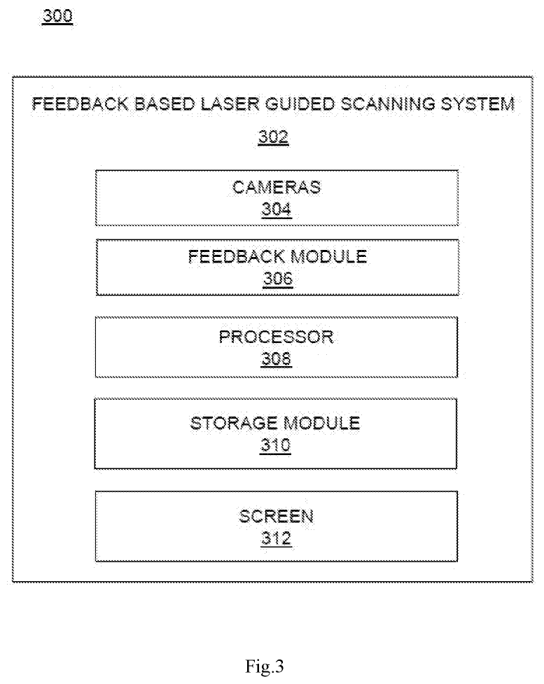

FIG. 3 is a block diagram 300 illustrating system elements of an exemplary feedback-based laser-guided scanning system 302, in accordance with an embodiment of the present disclosure. As shown, the feedback-based laser-guided scanning system 302 primarily includes one or more cameras 304, a feedback module 306, a processor 308, a storage module 310, and a screen 312. As discussed with reference to FIG. 1, the user 102 may use the feedback-based laser-guided scanning system 302 for capturing three-dimensional (3D) shots/images of the object 106 for scanning. In some embodiments, the feedback-based laser-guided scanning system 302 is configured to 3D scan the object 106.

In some embodiments, the feedback module 306 is configured to provide one or more feedback about an exact position for taking one or more shots. The feedback may include a new coordinate for taking a next shot of one or more shots of the object 106. The user 102 may move the feedback-based lased guided scanning system 302 to the exact position for taking the shot. The feedback may include an audio feedback, a video feedback, and combination of these. The audio feedback may include sounds, audio messages, and so forth. The video feedback may include video messages, displayed text, and so forth. In some embodiments, the video feedback may be displayed on the screen 312. For example, scanning information comprising position coordinate for taking the one or more shots may be displayed on the screen 312.

The one or more cameras 304 may be configured to capture one or more shots/images of the object 106 for completing a 360-degree view of the object 106. In some embodiments, the one or more cameras 304 may be configured to capture the one or more shots based the one or more feedback from the feedback module 306. In some embodiments, the feedback-based laser-guided scanning system 302 may have only one camera 304. The one or more cameras 304 may further be configured to take the plurality of shots of the object 106 based on a laser center coordinate and a relative width of a first shot of the plurality of shots. In some embodiments, the laser center coordinate may be kept un-disturbed while taking the plurality of shots of the object 106 after the first shot. For each of the plurality of shots, the feedback module 306 provides a feedback regarding an exact position for taking each of the shot. In some embodiments, the feedback module 306 includes at least one inbuilt speaker (not shown) for providing audio feedbacks or creating sounds.

The processor 308 may be configured to define the laser center coordinate for the object 106 from the first shot of the plurality of shots. An exact position for taking a shot may be defined without disturbing the laser center coordinate for the object 106. The exact position may comprise one or more position coordinates. The processor 308 may also be configured to stitch and process the plurality of shots in real-time to generate at least one 3D model including a scanned image of the object 106. The processor 308 may also be configured to define a new position coordinate of the user 102 based on the laser center coordinate and the relative width of the shot.

The storage module 310 may be configured to store the images and 3D models. In some embodiments, the storage module 310 may be a memory. In some embodiments, the laser-guided scanning system 302 may also include a button (not shown). The user 102 may capture the shots or images by pressing or touching the button.

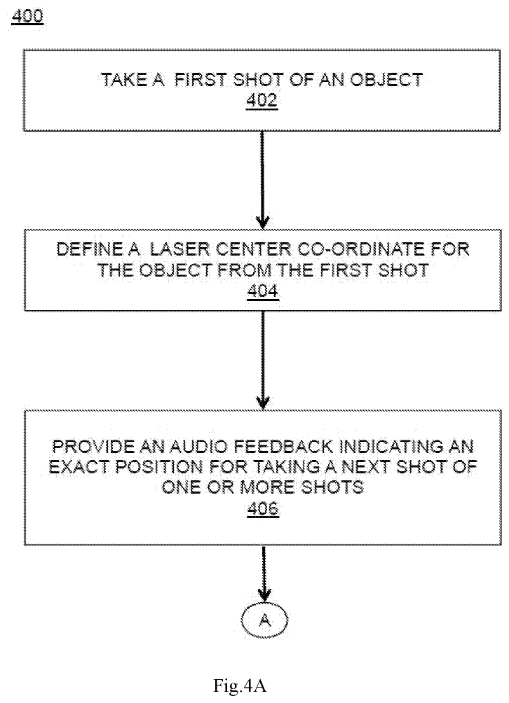

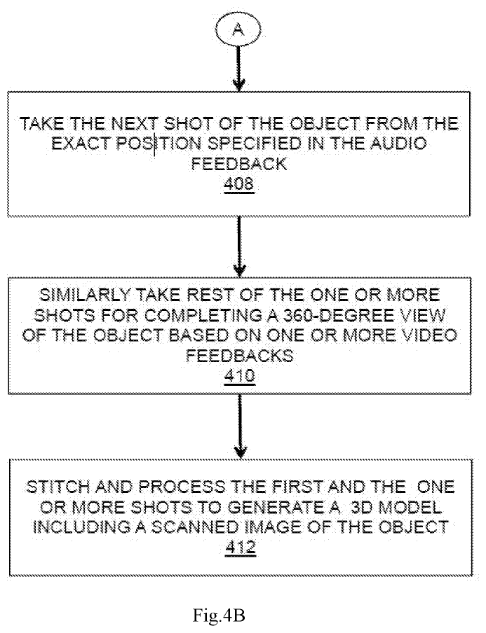

FIGS. 4A-4B illustrates a flowchart of a method 400 for a 3 dimensional (3D) scanning of an object based on an audio feedback, in accordance with an embodiment of the present disclosure. As discussed with reference to FIG. 3, the feedback-based laser-guided scanning system 302 primarily includes the one or more cameras 304, the feedback module 306, the processor 308, the storage module 310, and the screen 312. In some embodiments, the feedback module 306 comprises at least one speaker.

At step 402, the user 102 takes a first shot of the object 106 as discussed with reference to FIG. 1. Then at step 404, the processor 308 may define a laser center coordinate for the object 106 from the first shot. Then at step 406, an audio feedback indicating an exact position for taking a next shot of one or more shots is provided. The audio feedback may be provided by the feedback module 306 via the at least one speaker. The audio feedback may include a sound, an audio message, and so forth. The user 102 may move the feedback-based laser-guided scanning system 302 to the exact position. Then at step 408, the next shot is taken from the exact position specified in the audio feedback. Thereafter at step 410, similarly rest of the one or more shots of the object 106 are taken by following the steps 406-408 and based on one or more audio feedbacks for each of the one or more shots for completing a 360-degree view of the object 106. Finally at 412, the first shot and the one or more shots are stitched and processed to generate a three-dimensional (3D) model including a scanned image of the object 106. In some embodiments, the first shot and the one or more shots are processed and stitched in real-time.

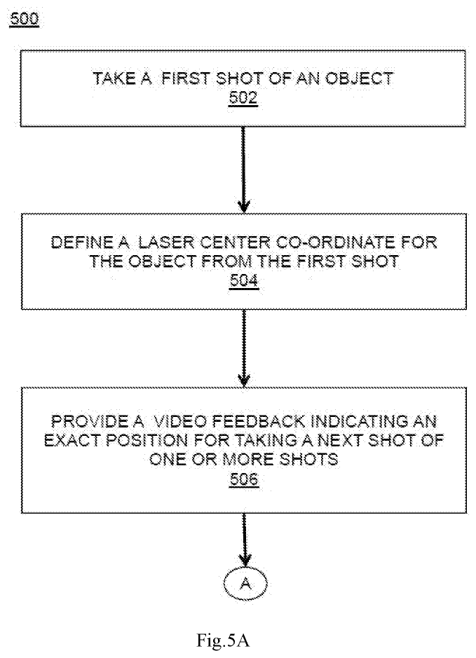

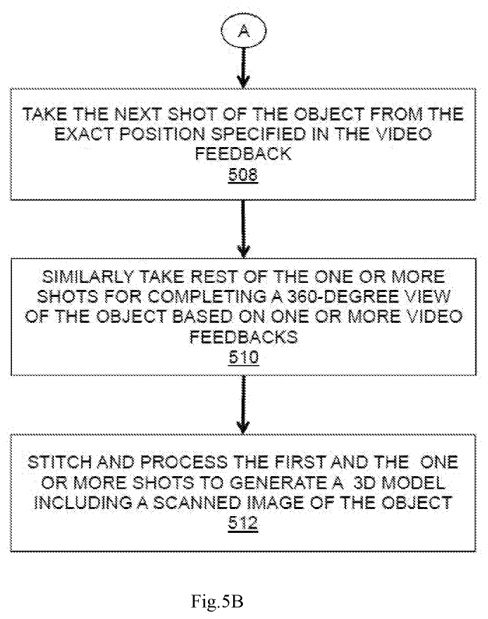

FIGS. 5A-5B illustrates a flowchart of a method 500 for a three-dimensional (3D) scanning of an object based on an audio feedback, in accordance with an embodiment of the present disclosure. As discussed with reference to FIG. 3, the feedback-based laser-guided scanning system 302 primarily includes the one or more cameras 304, the feedback module 306, the processor 308, the storage module 310, and the screen 312.

At step 502, the user 102 takes a first shot of the object 106 as discussed with reference to FIG. 1. Then at step 504, the processor 308 may define a laser center coordinate for the object 106 from the first shot. Then at step 506, a video feedback indicating an exact position for taking a next shot of one or more shots is provided. The feedback module 306 via the screen 312 may provide the video feedback. The video feedback may include a video, a message, and so forth. The user 102 may move the feedback-based laser-guided scanning system 302 to the exact position. Then at step 508, the next shot is taken from the exact position specified in the video feedback. Thereafter at step 410, similarly rest of the one or more shots of the object are taken by following the steps 406-408 and based on one or more video feedbacks for each of the one or more shots for completing a 360-degree view of the object 106. Finally at 412, the first shot and the one or more shots are stitched and processed to generate a three-dimensional (3D) model including a scanned image of the object 106. The processor 308 may process and stitch the shots in real-time.

According to another aspect of the present disclosure, the feedback-based laser-guided scanning system is configured to keep the laser center coordinate undisturbed while taking various shots. The laser-guided scanning system may take the shots based on the coordinate. A relative width of the shot may also be defined to help in defining the new coordinate of the user. Therefore, by not disturbing the laser center, the laser-guided scanning system may capture the overall or complete photo of the object. Hence, there may not be a missing part of the object scanning that in turn, may increase the overall quality of the scanned image or the 3D model.

According to another aspect of the present disclosure, the one or more cameras takes the plurality of shots of the object one by one based on the laser center coordinate and a relative width of the first shot.

Embodiments of the disclosure are also described above with reference to flowchart illustrations and/or block diagrams of methods and systems. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the acts specified in the flowchart and/or block diagram block or blocks. These computer program instructions may also be stored in a computer-readable memory that can direct a computer or other programmable data processing apparatus to operate in a particular manner, such that the instructions stored in the computer-readable memory produce an article of manufacture including instruction means which implement the acts specified in the flowchart and/or block diagram block or blocks. The computer program instructions may also be loaded onto a computer or other programmable data processing apparatus to cause a series of operations to be performed on the computer or other programmable apparatus to produce a computer implemented process such that the instructions which execute on the computer or other programmable apparatus provide steps for implementing the acts specified in the flowchart and/or block diagram block or blocks.

In addition, methods and functions described herein are not limited to any particular sequence, and the acts or blocks relating thereto can be performed in other sequences that are appropriate. For example, described acts or blocks may be performed in an order other than that specifically disclosed, or multiple acts or blocks may be combined in a single act or block.

While the invention has been described in connection with what is presently considered to be the most practical and various embodiments, it is to be understood that the invention is not to be limited to the disclosed embodiments, but on the contrary, is intended to cover various modifications and equivalent arrangements.

What is claimed is:

1. A laser-guided scanning system for scanning of an object, comprising:
a processor configured to:
define a laser center coordinate and a relative width for the object from a first shot of the object; and
define an exact position for taking each of one or more shots after the first shot, wherein the exact position for taking the one or more shots is defined based on the laser center coordinate and the relative width;
a feedback module configured to provide at least one feedback about the exact position for taking the one or more shots; and
one or more cameras configured to capture the first shot and the one or more shots one by one from the exact position based on the feedback, wherein a user moves the laser-guided scanning system to the exact position;
wherein the processor stitches and processes the first shot and the one or more shots in real-time to generate at least one three-dimensional model comprising a scanned image of the object.

2. The laser-guided scanning system of claim 1, wherein the feedback includes at least one of an audio message and a video message.

3. The laser-guided scanning system of claim 1, wherein the one or more cameras takes the one or more shots of the object one by one based on the laser center coordinate and a relative width of the first shot.

4. The laser-guided scanning system of claim 3, wherein the processor is further configured to define a new position coordinate for each of the one or more shots based on the laser center coordinate and the relative width of the first shot.

5. The laser-guided scanning system of claim 1, wherein the object comprises at least one of a symmetrical object and an unsymmetrical object.

6. The laser-guided scanning system of claim 1, wherein the feedback module creates a sound to provide information to the user for taking a next shot of the one or more shots.

7. A feedback-based laser-guided scanning system for scanning of an object, comprising:
an audio/video feedback module configured to provide a feedback about an exact position to a user for taking a plurality of shots comprising at least one image of an object, the feedback module further comprises a screen for showing information of scanning to the user, wherein the screen comprises at least one of a built in or a mounted visual system to showcase accuracy of taking shots to the user, the feedback comprising at least one of an audio message and a video message;
one or more cameras configured to capture the plurality of shots including the first shot and one or more shots one by one based on the feedback, the one or more shots are being shots taken after the first shot, the user moves the system to the exact position for taking the plurality of shots; and
a processor configured to:
define a laser center coordinate for the object from a first shot of the plurality of shots;
define the exact position for taking a next shot of the one or more shots without disturbing the laser center coordinate for the object; and
stitch and process the first shot and the one or more shots in real-time to generate at least one 3D model comprising a scanned image of the object.

8. The feedback-based laser-guided scanning system of claim 7, wherein the processor is further configured to define a new position coordinate for each of the one or more shots based on the laser center coordinate and the relative width of the first shot.

9. The feedback-based laser-guided scanning system of claim 7, wherein the feedback module creates a sound to provide information to the user for taking a next shot of the one or more shots.

10. The feedback-based laser-guided scanning system of claim 7, wherein the laser center coordinate is kept undisturbed while taking the one or more shots.

11. The feedback-based laser-guided scanning system of claim 7, wherein the object comprises at least one of a symmetrical object and an unsymmetrical object.

12. A method for scanning of an objects, comprising:
defining a laser center coordinate and a relative width for the object from a first shot of the object;
defining an exact position for taking each of one or more shots after the first shot, wherein the exact position for taking the one or more shots is defined based on the laser center coordinate and the relative width;
providing at least one feedback about the exact position for taking the one or more shots;
showing information of scanning to the user for taking shots with accuracy;
capturing the first shot and the one or more shots one by one from the exact position based on the feedback, wherein a user moves the laser-guided scanning system to the exact position; and
stitching and processing the first shot and the one or more shots in real-time to generate at least one three-dimensional model comprising a scanned image of the object.

13. The method of claim 12, wherein the feedback includes at least one of an audio message and a video message.

14. The method of claim 12, wherein the one or more shots of the object are taken one by one based on the laser center coordinate and a relative width of the first shot.

15. The method of claim 12 further comprising defining a new position coordinate for taking each of the one or more shots based on the laser center coordinate and the relative width of the first shot.

16. The method of claim 12 further comprising creating a sound to provide information to the user for taking a next shot of the one or more shots.

17. The method of claim 12 further comprising keeping the laser center coordinate undisturbed while taking the one or more shots.

18. The method of claim 12, wherein the object comprises at least one of a symmetrical object and an unsymmetrical object.

19.-20. (canceled)
